(19) United States
(12) Patent Application Publication
(10) Pub. No.: US 2013/0002573 A1
(43) Pub. Date: Jan. 3, 2013

(54) INFORMATION PROCESSING APPARATUS AND A METHOD FOR CONTROLLING THE SAME

(76) Inventor: Kunio Baba, Ome-shi (JP)

(21) Appl. No.: 13/419,128

(22) Filed: Mar. 13, 2012

(30) Foreign Application Priority Data
Jun. 30, 2011 (JP) 2011-146328

(51) Int. Cl. G06F 3/041

(52) U.S. Cl. 345/173

(57) ABSTRACT

According to one embodiment, an information processing apparatus includes a touchscreen display, a touchpad display module, and a pointer display module. The touchscreen display includes a touchpanel and a display. The touchpad display module is configured to display, on a display screen of the display, a virtual touchpad window includes a pad area. The pointer display module configured to display a pointer at a position corresponding to a change of a touch position within a first area of the touchscreen display if a position where the virtual touchpad window is first touched is within the pad area, the first area is an entire area of the touchscreen display.

### CROSS-REFERENCE TO RELATED APPLICATIONS

This application is based upon and claims the benefit of priority from prior Japanese Patent Application No. 2011-146328, filed Jun. 30, 2011, the entire contents of which are incorporated herein by reference.

### FIELD

Embodiments described herein relate generally to an information processing apparatus and a method for controlling the information processing apparatus.

### BACKGROUND

In recent years, information processing apparatuses without a mouse or keyboard, which have only a touchpanel as an input device, have become widespread. However, input operations by a finger on a small point on the touchpanel are difficult. Therefore, a virtual software touchpad application is known, which enables mouse operations similar to those of a touchpad by touch operations.

However, since the software touchpad is displayed on a screen to be operated, the software touchpad needs to have a limited size so that the software touchpad fits within a part of the screen. Therefore, a touch operation, such as a pointer moving operation, often goes beyond the software touchpad, and pointer movement is often interrupted.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an example of the appearance of an information processing apparatus according to an embodiment.

FIG. 2 is an exemplary block diagram showing an example of the configuration of the information processing apparatus according to the embodiment.

FIG. 3 is an exemplary block diagram showing an example of the configuration for displaying a virtual touchpad window on the LCD shown in FIG. 2.

FIG. 4 shows an example of the virtual touchpad window displayed on the LCD.

FIG. 5 shows an operation example of the virtual touchpad window.

FIG. 6 is an exemplary flowchart showing an example of processing performed by a touchpad program.

FIG. 7 shows a display example of the virtual touchpad window.

FIG. 8 shows a display example of the virtual touchpad window.

FIG. 9 shows a display example of the virtual touchpad window.

FIG. 10 shows a display example of the virtual touchpad window.

FIG. 11 shows a display example of a window.

FIG. 12 shows a display example of the virtual touchpad window.

FIG. 13 shows a display example of the virtual touchpad window.

### DETAILED DESCRIPTION

Various embodiments will be described hereinafter with reference to the accompanying drawings.

In general, according to one embodiment, an information processing apparatus includes a touchscreen display, a touchpad display module, and a pointer display module. The touchscreen display includes a touchpanel and a display. The touchpad display module is configured to display, on a display screen of the display, a virtual touchpad window comprising a pad area. The pointer display module configured to display a pointer at a position corresponding to a change of a touch position within a first area of the touchscreen display if a position where the virtual touchpad window is first touched is within the pad area, the first area is an entire area of the touchscreen display.

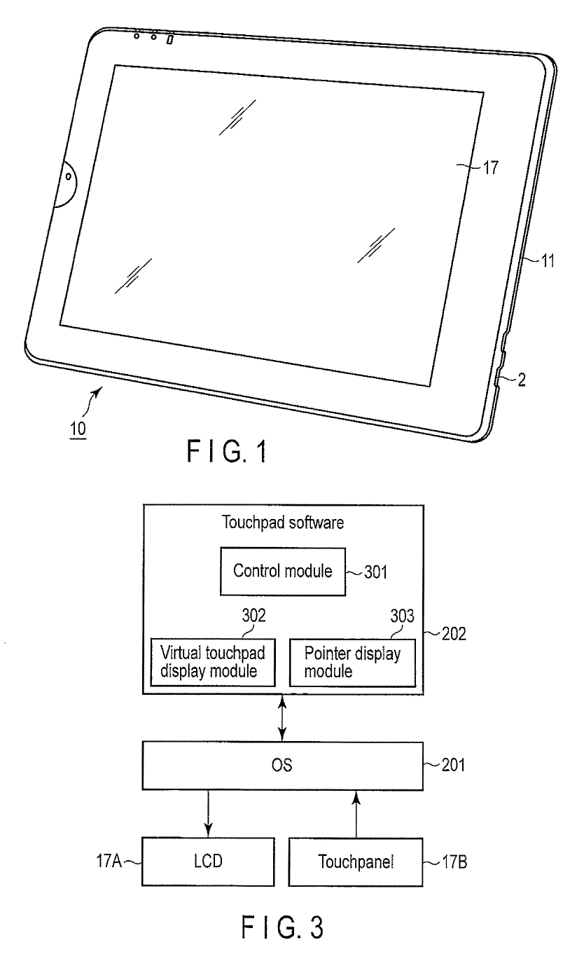

FIG. 1 is a perspective view showing an appearance of an information processing apparatus according to an embodiment. The information processing apparatus is realized as, for example, a tablet personal computer (PC) 10. The information processing apparatus may also be realized as, for example, a smartphone, a FDA, and a notebook PC. As shown in FIG. 1, the computer 10 comprises a computer main body 11 and a touchscreen display 17.

The computer main body 11 comprises a flat box housing. The touchscreen display 17 comprises a liquid crystal display (LCD) 17A and a touchpanel 17B. The touchpanel 17B is provided to cover a screen of the LCD 17A. The touchscreen display 17 is attached on the top surface of the computer main body 11.

On the upper surface of the computer main body 11, for example, a power button for turning on and off the computer 10, a volume control button, a memory card slot are arranged. On the lower surface of the computer main body 11, for example, a speaker is arranged. On the right surface of the computer main body 11, for example, a Universal Serial Bus (USB) connector 13 for connecting a USB cable and a USB-2.0-compliant USB device, and an external display connector 2 complying with the High-definition Multimedia Interface (HDMI) standard are arranged. The external display connector 2 is used for outputting a digital video signal to an external display.

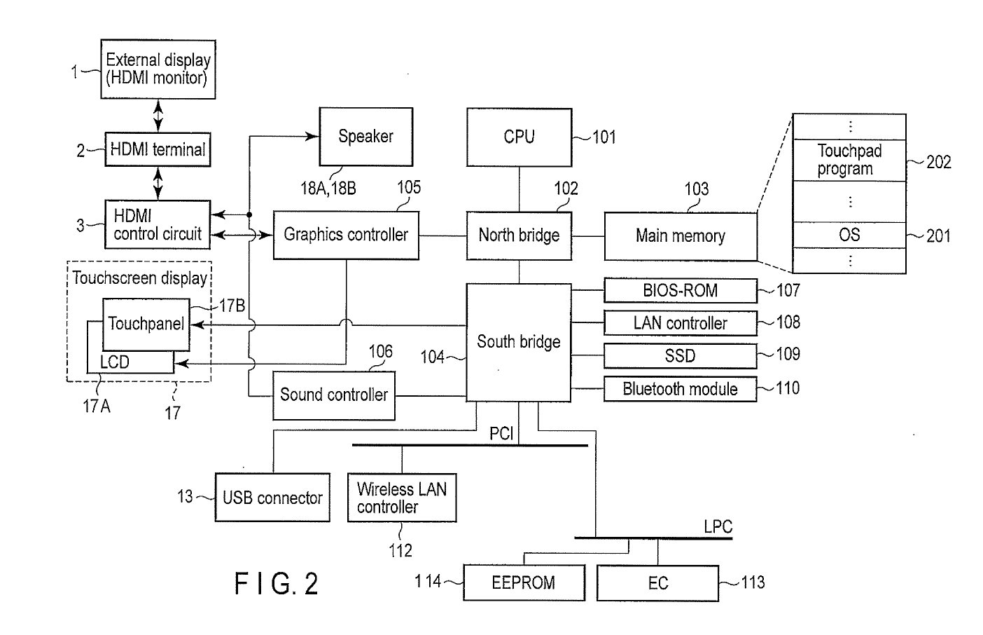

FIG. 2 shows a system configuration of the computer 10.

As shown in FIG. 2, the computer 10 comprises, for example, a CPU 101, a north bridge 102, a main memory 103, a south bridge 104, a graphics controller 105, a sound controller 106, a BIOS-ROM 107, a LAN controller 108, a solid-state drive (SSD) 109, a Bluetooth (registered trademark) module 110, a wireless LAN controller 112, an embedded controller (EC) 113, an EEPROM 114 and an HDMI control circuit 3.

The CPU 101 is a processor which controls the operation of each unit in the computer 10. The CPU 101 executes, for example, an operating system (OS) 201, a touchpad program 202 and various application programs, which are loaded from the SSD 109 to the main memory 103. The touchpad program 202 has a function of displaying a virtual touchpad on the LCD 17A.

The CPU 101 also executes a BIOS stored in the BIOS-ROM 107. The BIOS is a program for hardware control.

The north bridge 102 is a bridge device connecting a local bus of the CPU 101 to the south bridge 104. The north bridge 102 comprises a memory controller for performing access control of the main memory 103. Further, the north bridge 102 comprises a function of performing communications with the graphics controller 105 via, for example, a PCI Express serial bus.

The graphics controller 105 is a display controller which controls the LCD 17A used as a display monitor of the computer 10. A display signal generated by the graphics controller 105 is transmitted to the LCD 17A. The LCD 17A displays an image based on the display signal.

The HDMI connector 2 is the above-mentioned external display connector. The HDMI connector 2 can transmit an uncompressed digital video signal and a digital audio signal to the external display device 1 via one cable. The HDMI control circuit 3 is an interface for transmitting a digital video signal via the HDMI connector 2 to the external display device 1, which is called HDMI monitor. Accordingly, the computer 10 is connectable to the external display device 1 via, for example, the HDMI connector 2.

The south bridge 104 controls each device on a Peripheral Component Interconnect (PCI) bus and each device on a Low Pin Count (LPC) bus. The south bridge 104 comprises an Integrated Drive Electronics (IDE) controller for controlling the SSD 109.

The south bridge 104 comprises a USB controller for controlling the touchpanel 17B. The touchpanel 17B is a pointing device for performing input on the screen of the LCD 17A. Using the touchpanel 17B, a user can operate, for example, a graphical user interface (GUI) displayed on the screen of the LCD 17A. For example, by touching a button displayed on the screen, the user can give instructions to perform a function corresponding to the button. Further, the USB controller, for example, performs communications with an external device via a USB 2.0 cable connected to the USB connector 13.

Moreover, the south bridge 104 has a function of performing communications with the sound controller 106. The sound controller 106 is a sound generator, and outputs audio data to be reproduced by a speaker 18A, 18B. The LAN controller 108 is a wired communication device configured to perform wired communications based on, for example, IEEE 802.3. The wireless LAN controller 112 is a wireless communication device configured to perform wireless communications based on, for example, IEEE 802.11g. The Bluetooth module 110 is a communication module configured to perform Bluetooth communications with an external device.

The EC 113 is a single-chip microcomputer comprising an embedded controller for power control. The EC 113 has a function of turning on and off the computer 10 in response to a user's operation of the power button.

Next, referring to FIG. 3, a configuration for displaying a virtual touchpad on the LCD 17A will be described.

As shown in FIG. 3, the touchpad program 202 comprises, for example, a Control module 301, a virtual touchpad display module 302, and a pointer display module 303. The Control module 301 performs, for example, control of, for example, the virtual touchpad display module 302 and the pointer display module 303. The virtual touchpad display module 302 passes image data for displaying a virtual touchpad to the operating system 201, and causing the operating system 201 to display the virtual touchpad on the LCD 17A.

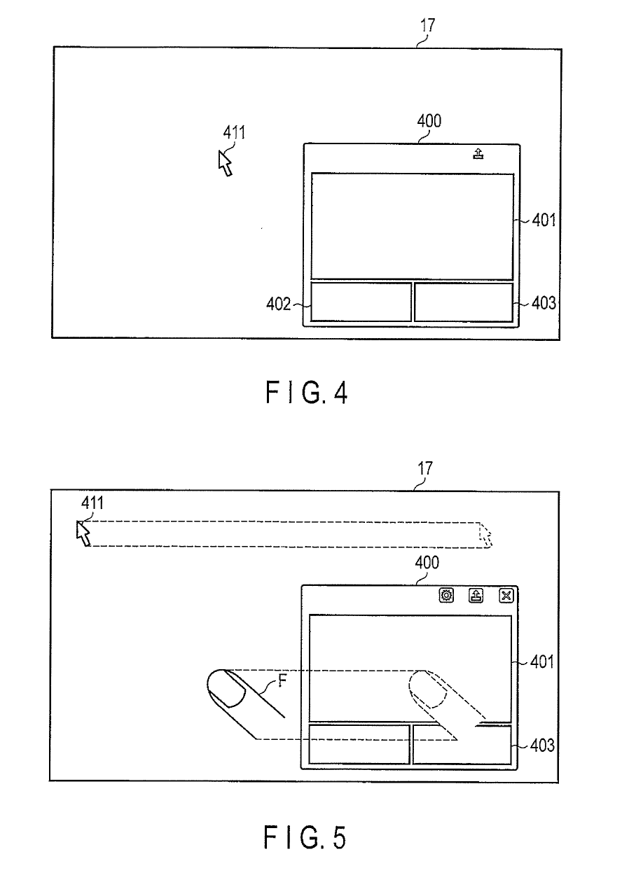

As shown in FIG. 4, a virtual touchpad window 400 is displayed on the display screen of the LCD 17A. The virtual touchpad window 400 comprises, for example, a pad area 401, a left button 402 and a right button 403.

When the touchpanel 17B is touched, the touchpanel 17B passes position coordinates of the touch position to the operating system 201. The operating system 201 passes the position coordinates of the touch position to a program which is displaying the window located at the received position coordinates. The operating system 201 continues to pass position coordinates to the program to which position coordinates were first passed even if the touch position moves out of the window.

If the position coordinates of the operation position first passed from the operating system 201 are within the left button 402 or the right button 403, the Control module 301 passes a corresponding event to the operating system 201.

If the position coordinates of the operation position first passed from the operating system 201 are within the pad area 401, the pointer display module 303 changes a display position of a pointer 411 in accordance with change of the position coordinates of the operation position.

A user starts a touch on the pad area 401 by, for example, a finger and slides the finger within the pad area 401 without moving the finger off the pad area 401 to move the pointer 411. In the case of a normal touchpad, the pointer 411 can be moved only in response to a touch operation within the pad area 401, and if the touch operation moves out of the pad area 401, the pointer 411 is not moved.

In the present embodiment, as shown in FIG. 5, a touch operation started from within the pad area 401 is recognized with the assumption that the pad area 401 is virtually expanded all over the touchscreen display 17, and even if the touch operation moves out of the pad area 401, the moving operation of the pointer 411 is continuously performed.

The pad area 401 is only virtually expanded all over the touchscreen display 17, and the perceived size of the virtual touchpad window 400 is not changed as shown in FIG. 5.

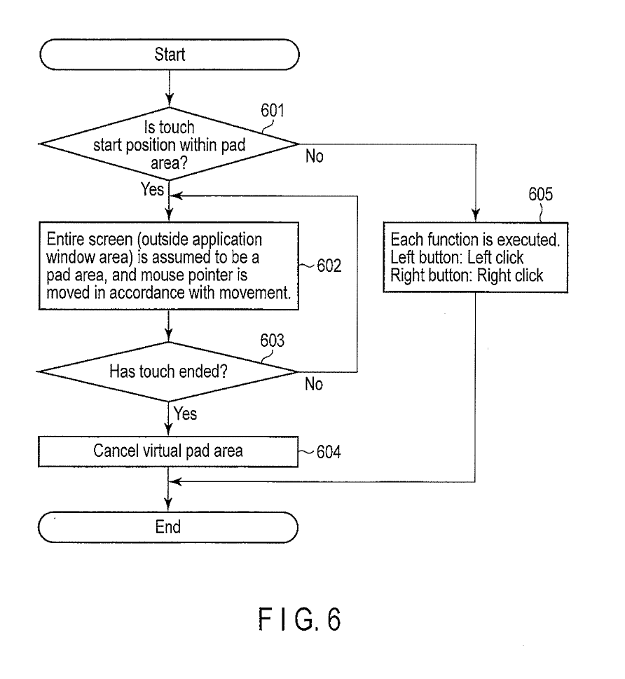

Referring to FIG. 6, processing performed by the touchpad program 202 will be described.

When the positional coordinates of the operation position are passed from the operating system 201 to the pointer display module 303, the Control module 301 determines whether the start position of the touch operation is within the pad area 401 (block 601). If the Control module 301 determines that the start position is not within the pad area 401 (No in block 601), the Control module 301 issues a left-click event to the operating system 201 when the left button 402 is touched, and issues a right-click event to the operating system 201 when the right button 403 is touched (block 605).

If the Control module 301 determines that the start position is within the pad area 401 (Yes in block 601), the Control module 301 virtually expands the pad area 401 all over the touchscreen display 17. The pointer display module 303 continues the moving and display operation of the pointer 411 by the touch operation on the entire touchscreen display 17 (block 602).

The Control module 301 determines that a user has stopped the mouse operation by the touch operation, i.e., end of the touch (block 603). When the Control module 301 determines that the touch has ended (Yes in block 603), the Control module 301 cancels the virtual expansion of the pad area 401 all over the touchscreen display 17, and enables the user to freely touch objects other than the virtual touchpad window 400 (block 604).

The user also performs a touch operation on objects within an area other than the virtual touchpad window 400, pad area expansion processing is performed only while a touch operation started from the pad area 401 of the virtual touchpad window 400 is continuing.

If a pointer operation is started by a touch on the pad area 401 of the virtual touchpad window 400, the entire screen is virtually recognized as the pad area while the displayed pad area 401 is disregarded to enable the pointer operation to be continuously performed until the touch ends, thereby improving operability.

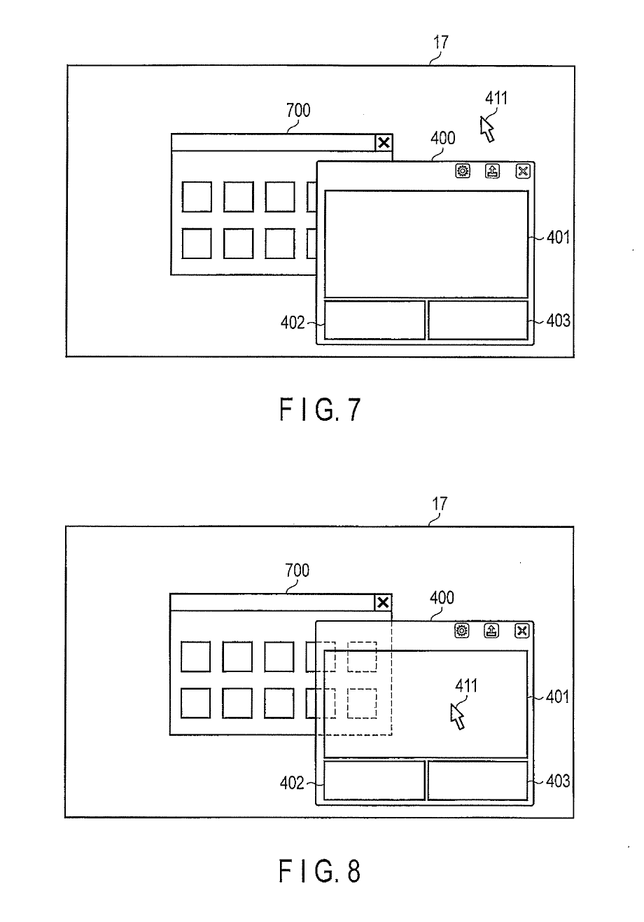

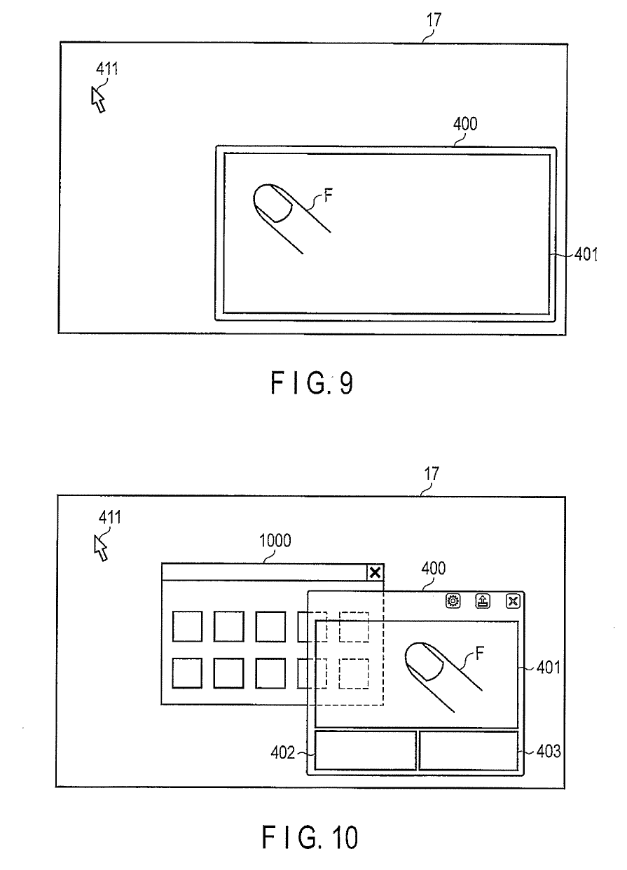

The virtual touchpad display module 302 may be configured not to display an area of the window 700 overlapping the virtual touchpad window 400 when the pointer 411 is not on the virtual touchpad window 400 as shown in FIG. 7, and to display the area of window 700 overlapping the virtual touchpad window 400 by displaying a translucent virtual touchpad window 400 when the pointer 411 is on the virtual touchpad window 400 as shown in FIG. 9.

As shown in FIG. 9, the virtual touchpad display module 302 may be configured to change the size of the virtual touchpad window in accordance with the touch position of finger F. The buttons may be dismissed during the moving operation of the pointer 411 as shown in FIG. 9, and may also be displayed.

As shown in FIG. 10, the virtual touchpad display module 302 may be configured to display an area of window 1000 overlapping the virtual touchpad window 400 by displaying a translucent virtual touchpad window 400 immediately after finger F touches the pad area 401.

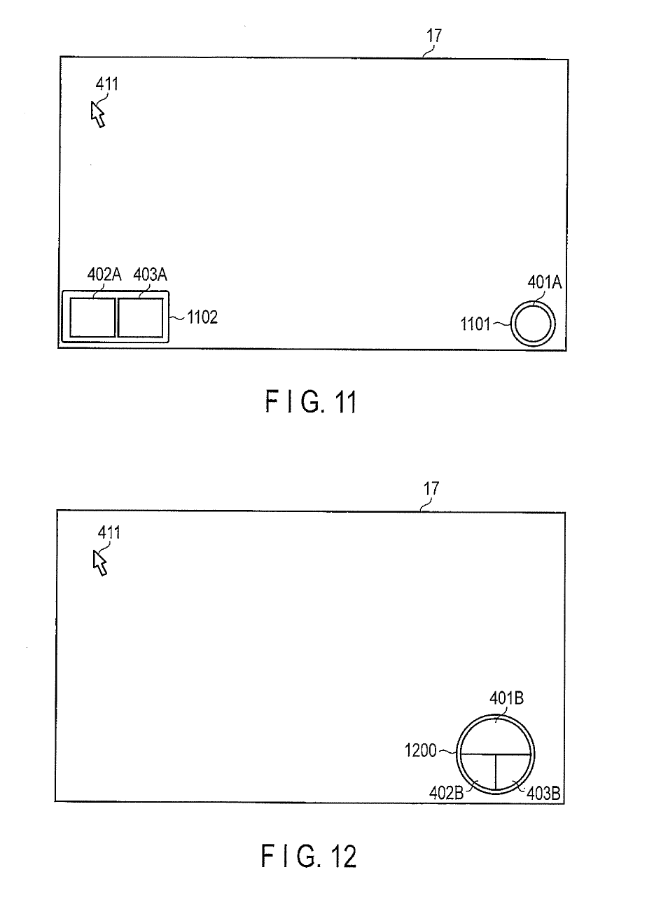

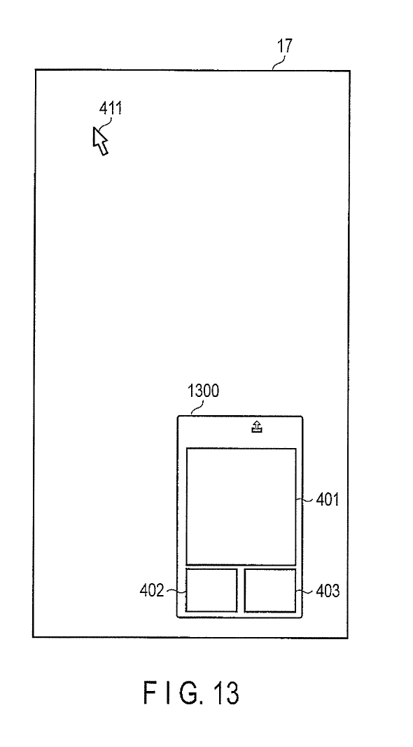

As shown in FIG. 11, the virtual touchpad display module 302 may be configured to display window 1101 including the pad area 401 and window 1102 including a left button 402A and a right button 403A.

As shown in FIG. 12, the virtual touchpad display module 302 may be configured to display a circular virtual touchpad window 1200. The virtual touchpad window 1200 includes a semicircular pad area 401B, a quarter-circular left button 402B and a quarter-circular right button 403B.

The information processing apparatus may comprise a gravity sensor for detecting the orientation of the apparatus. Based on the detection signal from the gravity sensor, the aspect ratio of the pad area 401 within virtual touchpad window 1300 may be changed. It is recommendable that the aspect ratio is set to correspond to the aspect ratio of the touchscreen display 17.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a touchscreen display comprising a touchpanel and a display;
a touchpad display module configured to display, on a display screen of the display, a virtual touchpad window comprising a pad area; and
a pointer display module configured to display a pointer at a position corresponding to a change of a touch position within a first area of the touchscreen display if a position where the virtual touchpad window is first touched is within the pad area, the first area being an entire area of the touchscreen display.

2. The apparatus of claim 1, wherein the touchpad display module is configured to display a translucent virtual touchpad window if the pointer enters a display area of the virtual touchpad window.

3. The apparatus of claim 1, wherein the touchpad display module is configured to change a size of the pad area in accordance with the touch position of the touchscreen display if the pointer display module displays the pointer at the position corresponding to the change of the touch position within the first area.

4. The apparatus of claim 1, wherein the touchpad display module is configured to further display a virtual button window comprising a button.

5. The apparatus of claim 1, wherein the touchpad display module is configured to display a translucent virtual touchpad window if the position where the virtual touchpad window is first touched is within the pad area.

6. A method for controlling an information processing apparatus comprising a touchscreen display comprising a touch panel and a display, the method comprising:
displaying, on a display screen of the display, a virtual touchpad window comprising a pad area; and
displaying a pointer at a position corresponding to a change of a touch position within a first area of the touchscreen display if a position where the virtual touchpad window is first touched is within the pad area, the first area being an entire area of the touchscreen display.

7. The method of claim 6, further comprising displaying a translucent virtual touchpad window if the pointer enters a display area of the virtual touchpad window.

8. The method of claim 6, further comprising changing the size of the pad area in accordance with the touch position of the touchscreen display if the pointer is displayed at the position corresponding to the change of the touch position within the first area.

9. The method of claim 6, further comprising displaying a virtual button window comprising a button.

10. The method of claim 6, further comprising displaying a translucent virtual touchpad window if the position where the virtual touchpad window is first touched is within the pad area.
